(19) United States
(12) Patent Application Publication
(10) Pub. No.: US 2010/0220309 A1
(43) Pub. Date: Sep. 2, 2010

(54) SOLAR POWERED RANGEFINDER

(76) Inventors: Jie Zhu, Chongqing (CN); Lin Xu, Chongqing (CN); Shiquan Jiang, Chongqing (CN)

Correspondence Address: BUTZEL LONG;IP DOCKETING DEPT, 350 SOUTH MAIN STREET, SUITE 300, ANN ARBOR, MI, 48104, US

(21) Appl. No.: 12/577,615

(22) Filed: Oct. 12, 2009

(30) Foreign Application Priority Data
Mar. 2, 2009 (CN) 200920126502.3

(51) Int. Cl. G01C 3/08

(52) U.S. Cl. 356/4.01

(57) ABSTRACT

A rangefinder for measuring a distance to a target includes a housing having a front wall, an opposed rear wall, first and second side walls disposed between the front and rear walls, an upper wall, and an opposed lower wall. The rangefinder also includes a transmission device for transmitting a signal towards a target, a receiving device for receiving a reflected signal from the target, and a distance measuring mechanism for determining the distance to the target using the transmitted signal and the reflected signal. A display device is in communication with the distance measuring mechanism for displaying the determined distance to the target. A solar power supply mechanism supplies solar power to operate the rangefinder, and includes a solar energy collector positioned on an outer surface of the housing that is operatively in communication with an energy storage device.

### CROSS REFERENCE TO RELATED APPLICATIONS

This application claims priority of Chinese Utility Model Patent Application Serial No. 200920126502.3 filed Mar. 2, 2009, which is incorporated herein by reference.

### BACKGROUND

1. Field

The present invention relates generally to a rangefinder for measuring a distance to a target, and more particularly to a solar powered rangefinder for measuring a distance to a target.

2. Description of the Related Art

Various types of portable, handheld devices are utilized for measuring a distance to a target. In an outdoor setting, a rangefinder may be utilized in determining the distance between the user and the target, such as a laser rangefinder. The laser rangefinder transmits a signal towards a target, the signal is reflected back from the target to the rangefinder, and evaluated by the rangefinder to calculate the distance between the operator and the target, which is communicated to the operator. More recently, the use of portable, handheld laser rangefinders are gaining in popularity while engaged in recreational endeavors, such as golf, hunting or other activities where it is desirable to measure a distance.

The compact size of the laser rangefinder enhances its functionality for the user, and yet may limit packageability of components within the housing. For example, there may be constraints on the size of the power source that may fit within the laser rangefinder housing. In addition, the components housed within the laser rangefinder will have predetermined power requirements that may influence the type of power source. While present laser rangefinders work well using conventional power sources, such as non-rechargeable batteries, the limited battery life influences the subsequent operating cost of the laser rangefinder. Thus there is a need in the art for a rangefinder that utilizes solar power for operation.

### SUMMARY

Accordingly, a solar powered laser rangefinder is provided. The solar powered laser rangefinder includes a housing having a front wall, an opposed rear wall, first and second side walls disposed between the front and rear walls, an upper wall, and an opposed lower wall. The rangefinder also includes a transmission device for transmitting a signal towards a target; a receiving device for receiving the reflected signal from the target; a distance measuring mechanism for measuring the distance to the target by performing calculations based on the transmitted signal and the transmitted signal reflected from the target; and a solar power supply mechanism positioned on the outer surface of the housing for supplying solar power to the rangefinder apparatus.

Also provided, a method of powering a solar powered rangefinder, the method includes the steps of collecting solar energy via a solar panel positioned on the housing of the rangefinder; converting the solar energy into electrical energy; transmitting the electrical energy to an energy storage device; and supplying electrical energy from the energy storage device to components of the solar powered rangefinder requiring electrical energy for operation. The method also includes the steps of determining the charge level of the energy storage device; comparing the charge level of the energy storage device to a predetermined energy storage device charge capacity level; terminating collection of solar energy when the charge level of the energy storage device is equal to the predetermined energy storage device charge capacity level; and continuing collection of solar energy when the charge level of the energy storage device is less than the predetermined energy storage device charge capacity level.

One advantage of the present disclosure is that a solar powered laser rangefinder is provided that uses solar energy to charge a storage battery. Another advantage of the present disclosure is that the solar energy storage device, such as a solar battery, has a longer lifespan than a conventional non-rechargeable battery. Still another advantage of the present disclosure is that the use of a solar energy storage device is more cost effective over the life span of the rangefinder. A further advantage of the present disclosure is that since the rangefinder is primarily used in an outdoor setting, the battery can be charging while in use. Still a further advantage of the present disclosure is that it is environmentally friendly since battery disposal is reduced. Still yet a further advantage is that the rangefinder can be utilized as a both telescope to enlarge an image and as a measuring tape to measure the distance between the user and the object.

Other features and advantages of the present disclosure will be readily appreciated, as the same becomes better understood after reading the subsequent description taken in conjunction with the accompanying drawings.

### BRIEF DESCRIPTION OF THE DRAWINGS

FIG. 1 is a perspective exterior view of a solar powered rangefinder.

FIG. 2 is perspective interior view of the solar powered rangefinder of FIG. 1.

FIG. 3 is a block diagram of the operating components for the solar powered rangefinder.

FIG. 4 is a diagram illustrating the charging circuit for the solar powered rangefinder.

FIG. 5 is a diagram illustrating the charging circuit for the solar powered rangefinder.

FIG. 6 is a flowchart illustrating a method of power distribution for the solar powered rangefinder.

### DETAILED DESCRIPTION

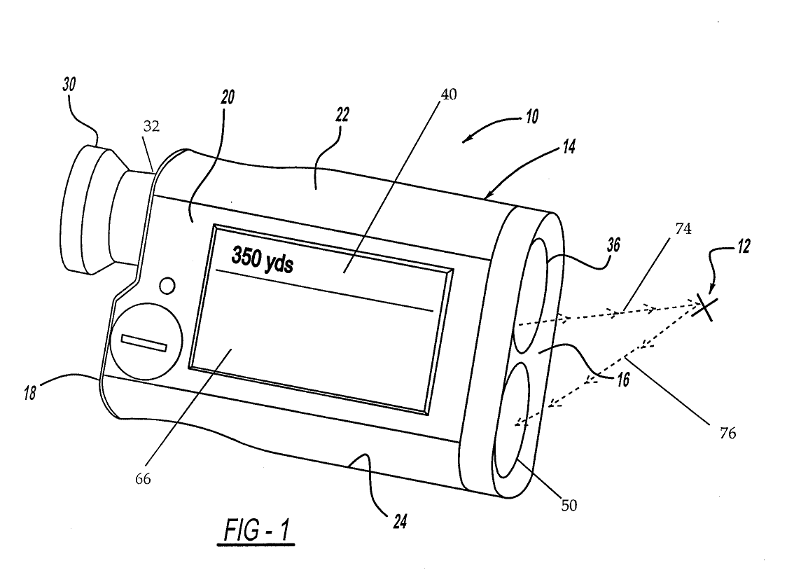

Referring to FIGS. 1-5, a solar powered rangefinder 10 is illustrated. The rangefinder 10 of this example is multifunctional, and may be used to observe a magnified image of a target 12, and to measure the distance to the target 12.

The rangefinder 10 includes a housing 14 having a front wall 16, an opposed rear wall 18, side walls 20 disposed between the front and rear walls, and an upper wall 22 and an opposed lower wall 24 disposed between the side walls to form an enclosed structure. In this example, the walls of the housing 14 form a generally box-like shape. The overall shape of the housing 14 may be ergonomically selected in order to fit comfortably within the hand of a user. Also in this example the housing 14 is made from a plastic material, although other materials, or combination of materials may be used.

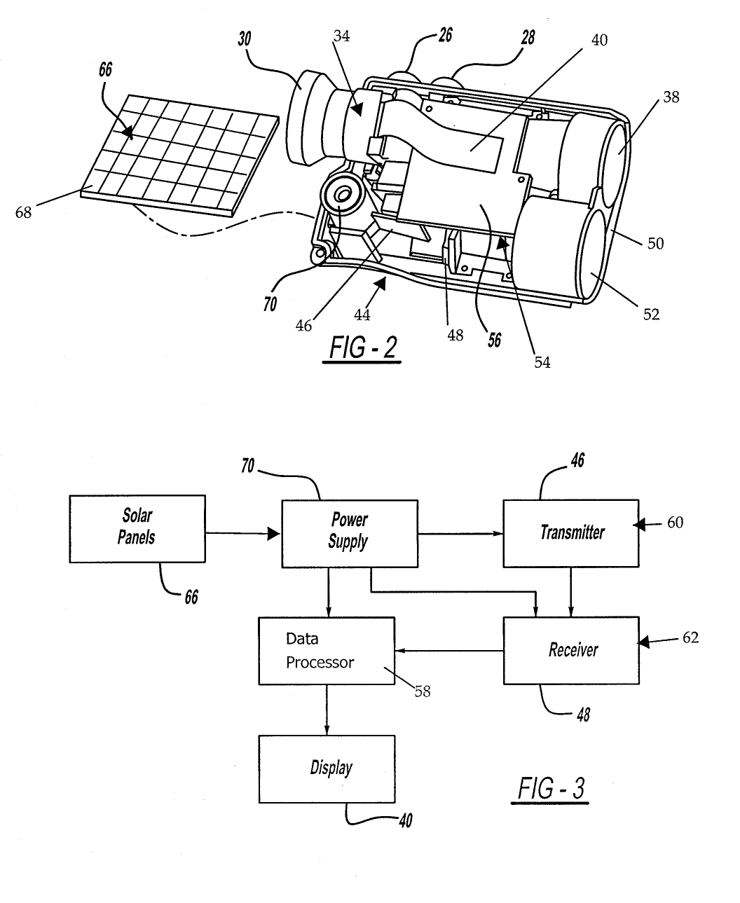

The housing 14 supports a first user actuatable mechanism 26 as shown in FIG. 2 for operating the rangefinder 10, such as for selecting an operating mode of the rangefinder 10 in a manner to be described. Various operating modes are available such as rain, reflective, minimum distance, or the like. An example of a first user selectable mechanism 26 is a first switch having a predetermined actuation, such as a push button switch, rocker switch, rotary switch, slide switch or the like. The housing 14 also supports a second user actuatable mechanism 28 for operating the rangefinder 10, such as a signal triggering mechanism for transmitting a laser signal to the object. An example of a signal triggering mechanism is a second switch having a predetermined actuation, such as a push button switch, a rocker switch, a rotary switch, a slide switch or the like. Another example of a signal triggering mechanism is a power switch that turns the rangefinder 10 on and off. In this example, the power switching function is included within the second user actuatable mechanism, or switch. In another example, the power switching function is included within a third user actuatable mechanism or switch (not shown). The switches 26, 28 are located within the housing 14 so as to be ergonomically convenient for a user to operate, such as within a housing upper wall 22.

An eyepiece 30 is integrally secured to a rear wall 18 of the housing 14. The eyepiece 30 of this example is a generally cylindrical member having a hollow interior portion that is centered about an eyepiece opening 32 in the rear wall 18 of the housing 14. An optical lens (not shown) is disposed within the eyepiece 30 and functionally provides the user with a magnified image of the target or object 12 and information about the target. The optical lens is operatively connected to a telescopic mechanism 34 for magnifying the size of the object viewed by the user, in a manner to be described.

The front wall 16 includes a first opening 36 that is opposite the eyepiece opening 32 in the rear wall 18 to form a first optical pathway, shown at 38. In this example, the front wall 16 opening is circular, although other shapes are contemplated. The telescopic mechanism 34 is disposed within the first optical pathway 38, and may be monocular, or binocular or the like. An example of a telescopic mechanism 34 is a refractor telescope that uses a plurality of optic lenses, such as prisms, to enlarge the object. Another example of a telescopic mechanism 34 is a reflector telescope that uses a plurality of optic lenses, such as mirrors, to enlarge the object. The optic lenses are arranged so that the light from the object is collected and is bent towards a focus point. The light is then transferred to an eyepiece lens having a similar size to that of the retinal portion of the user' eye, and magnifies the light so that the light takes up a large portion of the user's retina.

The range finder 10 includes a data display panel 40, which in this example is located within the first optical pathway 38 at a focal point and viewable by the user through the eyepiece 30 to provide the user with information concerning the target and the target distance. In another example, the data display panel is disposed within a wall of the housing 14 and externally viewable. In still another example, the range finder includes multiple data display panels 40 both within the first optical pathway 38 and disposed in the housing 14. Various types of information may be shown on the display panel 40, such as an alignment mark used to align the target 12 on the display screen 40 within the sight of the distance measuring mechanism, a distance measurement, a distance unit, the mode (rain, reflective and interfering targets within a predetermined distance), quality of the distance measurement, a laser emitting indicator, and a battery state indicator, or the like. The display panel 40 is transparent in order to view the magnified image of the target 12 being measured. For example, the display panel 40 may be a liquid crystal display panel, although other types of display panels may be utilized.

The rangefinder 10 also includes a distance measuring mechanism 44 disposed within the housing 14. Various types of distance measuring mechanisms may be utilized to determine the range to a target. In this example the distance measuring mechanism 44 uses natural properties associated with light transmission in order to calculate a distance between the target 12 and the rangefinder, such as with a semiconductor laser. In another example, natural properties of sound transmission such as sonar can be used in distance calculation. The distance measuring mechanism 44 includes a transmission device 46 and a receiving device 48. For example, the transmission device 46 is a laser light transmitter, such as a laser light diode, that transmits a predetermined amount of laser light energy along the first optical pathway 38. The laser light energy is reflected, such as via prisms or the like, into the optical pathway 38, and emitted through the front wall first opening 36 towards the target 12. The user directs the light path by aiming the transmitted light toward the target 12 by centering the target 12 within the alignment mark on the display panel 40. The front wall 16 also includes a second opening 50 for receiving a signal reflected back from the target 12, and the received signal is directed along a second optical pathway 52 to the receiving device 48, such as a laser light receiving device. For an example of a monocular telescope optic device, the laser receiver has an independent laser receiver antenna, which in this example is placed by its side, coaxial to the telescope. In another example of a binocular telescopic optic device, a second optical pathway is provided, having a second group of prisms that are utilized to receive the laser beam reflected by the target 12 and direct the received light to the laser receiver.

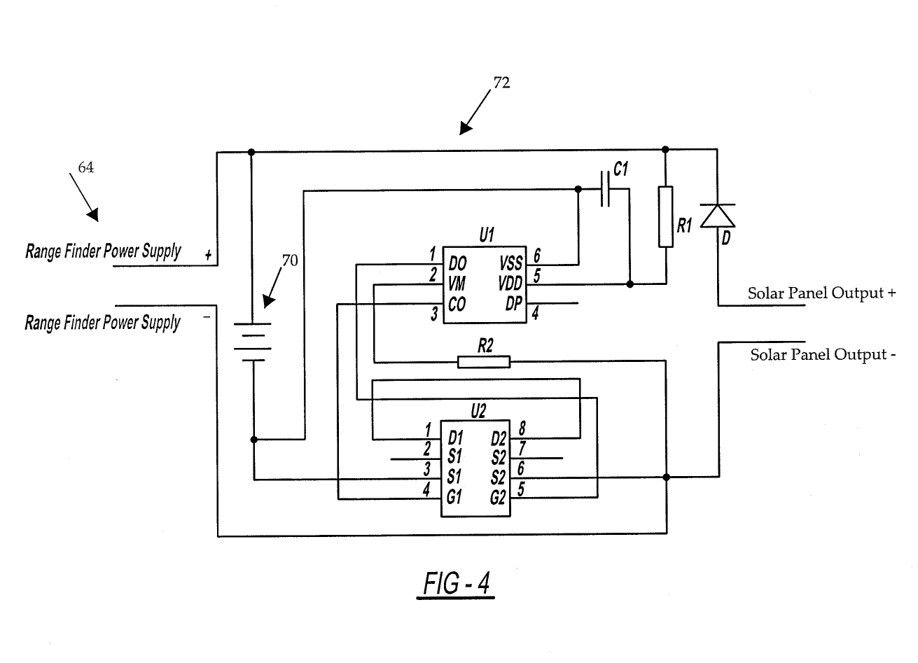

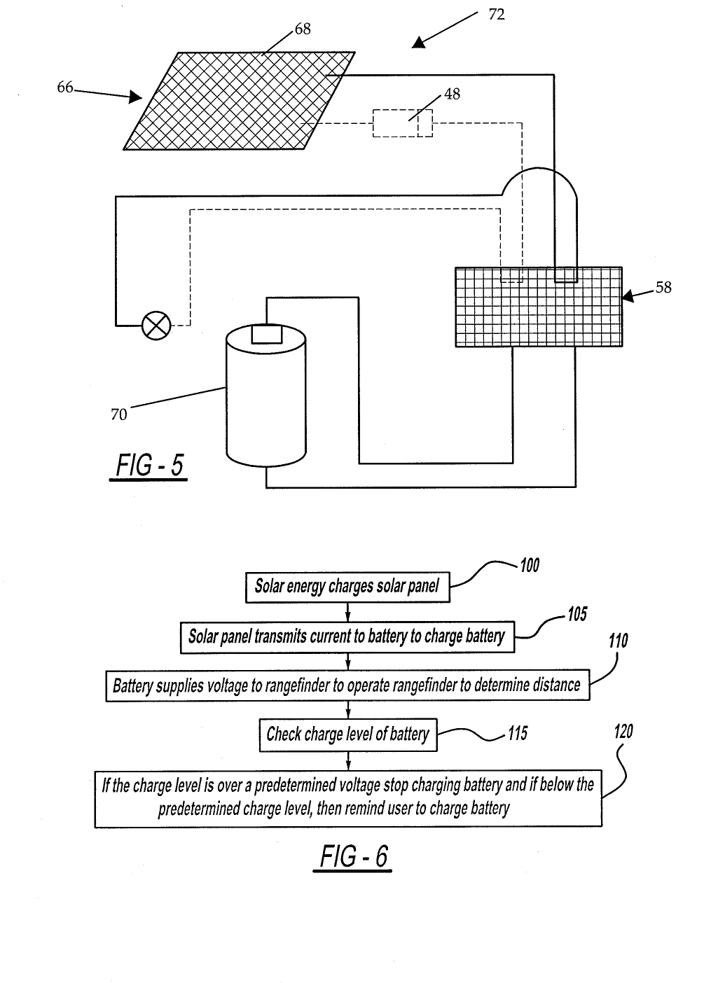

Referring to FIGS. 4-5, the light transmission device 46 and light receiving device 48 are operatively in communication with a controller 54, that is also contained within the housing 14, such as on a printed circuit board as shown at 56. The controller 54 includes a processor and a memory in order to control operation of the rangefinder 10. The controller 54 is part of a data processing circuit 58 that processes data in multiple modes from the laser receive circuit and then displays the information directly on the display panel. The controller is also operatively part of a drive circuit 60 for the rangefinder 10. A trigger signal, a power signal and a laser sampling signal are provided as inputs to the drive circuit, and the drive circuit operatively communicates with the laser transmission device 46 to emit a laser output signal that is directed towards the target 12. The rangefinder 10 electronics also includes a receiving circuit. The receiving circuit receives a power input, and a laser return signal reflected from the target 12. The laser return signal is conditioned as necessary and is provided as an input to a data processing circuit. The data processing circuit receives the emitted laser sampling signal and the laser return signal utilizes these signals as an input to the processor. The processor then evaluates these signals and outputs a trajectory calculation or distance to the target 12 that is operatively displayed on the display panel 40.

A data processing software program is resident in the memory of the controller 54 and controls the operation of the rangefinder. For example, an executable distance calculating methodology is stored within a memory of the controller and is called upon in order to measure the distance between the user and the target 12 via the distance measuring mechanism. An example of a distance measuring methodology is discussed, although other examples of distance measuring techniques are contemplated. In this example, the laser transmission device 46 emits a predetermined sequence of laser pulses towards the target 12. In this example, three pulses having a frequency between 50 to 100 Hz are emitted sequentially. That is, another pulse is not emitted until the previous pulse has returned. Thus, the frequency is dependent on the distance to the target, with a larger distance corresponding to a smaller frequency. The series of three pulses may be repeated a predetermined number of times, such as eight. The methodology utilizes the reflected pulses returned from the target in order to calculate the distance to the target 12.

The processing software initially analyzes the returned pulses to determine if the returned pulse is an actual signal pulse or a noise signal pulse. Various signal discrimination strategies may be utilized to determine if the returned signal pulse is a noise signal. For example, a value corresponding to the returned signal may be compared to a previous returned signal pulse value to determine if the present returned signal is within a predetermined range for a previous returned signal pulse.

In this example, each sequence of three returned signal pulses is analyzed to establish the distance to the target 12 by applying the Sun Zi Theorem, also referred to as the Chinese Remainder theorem. Once the laser pulse is emitted, a first cyclic or periodic counter starts to count at a predetermined rate, such as 100 MHZ until the first pulse is returned. An example of a first period is from 1 to 7. The first periodic counter stops when the first pulse is received, and the remainder of the first period is stored in the memory i.e. 7 minus the value the period counter stops at. The second pulse is emitted, and the second periodic counter starts counting for a second period until the second pulse is returned, which in this example is 13. The remainder of the second periodic counter is stored in memory. Similarly, a third periodic counter begins counting when a third pulse is transmitted and stops counting when the third pulse is received. The remainder from the third periodic counter is stored in memory. Each of the three separate remainders determined from the incomplete period of the transmitted and received laser pulse is utilized in the Chinese Remainder Theorem calculation to determine the distance. The period of each counter is selected to that each corresponding periodic value is pairwise coprime, to satisfy an initial condition of the Chinese Remainder theorem. By applying the Chinese Remainder Theorem to each series of remainders, a value corresponding to the distance between the rangefinder and the target may be generated. In this example, this sequence of pulses is repeated a predetermined number of times, which in this example is eight.

The methodology also determines if the returned signal is an actual signal or a noise signal, such as by comparing the returned signal to an adaptive noise threshold signal value, to be described. The adaptive noise threshold signal value has an initial value, which is selectively determined based on a desired error rate. In this example, the initial value is set one time using a potentiometer. The adaptive noise threshold signal value varies according to the noise pulse outputs.

The methodology determines if a predetermined number of sets of distance data are within a predetermined error tolerance. If the calculated distance data is not within the predetermined error tolerance, the distance data is considered void. Otherwise, the distance data is considered valid and is communication by the controller, such as for display on the display screen.

For example, to calculate the distance data, the maximum distance remainder of the incomplete period of the frequencies f_{A}, f_{B}, and f_{C}, is referred to as ΔN_{A}, ΔN_{B}, and ΔN_{C} respectively. These maximum distance remainders will satisfy the following relationships for the measured distance:

X≡ΔN_{A}M₁′M₁+ΔN_{B}M₂′M₂+ΔN_{C}M₃′M₃(mod M) (1)

Thus, the congruence expression is satisfied as follows:

Mᵢ′Mᵢ≡1(mod mᵢ) i=1,2,3 (2)

M=f_{A}×f_{B}×f_{C} (3)

The positive integer solution M of the above equations is the measured distance.

The software also evaluates whether the reflected return signal is an actual reflected signal or a noise signal. If the signal is a noise signal, the threshold is lowered. The values are compared, and if they do not compare, the reflected return signal may be noise. The software program may limit the number of iterations. For example, if 2 or 3 of the signals are noise, then the counter is stopped. As described, the software adaptively learns from the previous sequence of signals adjust the threshold used in determining signal noise. For example, if the noise is increasing, the adaptive noise threshold also increases. The adaptive noise threshold or Floating Alarm Rate is determined using the following analysis:

FAR=[(C×Pt)÷2R]×N

Where,
C=Speed of the light
Pt=Maximum value of the noise measurement
R=Maximum measured distance capability of the distance measuring Equipment
N=Predetermined number of reflected return laser received and placed in accumulator, and N is determinable from the technical specifications and requirements of the measurement equipment The range finder may also provide an indication of the reflective quality of the target. In this example, the reflective quality of the target is based on the number of matches or valid distance measurements and the accumulated number of reflected return pulses that exceed the adaptive noise threshold value.
Assume N=predetermined number used to define lowest quality accumulated signal
Assume A=number of valid distance measurements
Low Quality Level if N≦A≦2N
Mid Quality Level if 2N≦A≦3N
High Quality Level if A≧3N
   The determined quality level may be communicated by to controller to the display panel and displayed thereon.

The rangefinder 10 also includes a power supply mechanism 64 that distributes power as necessary to the various components affiliated with the operation of the rangefinder. The power supply mechanism 64 includes a solar energy collector 66, such as a panel. The solar panel 66 is integrally positioned within a housing wall. Other components associated with the power supply mechanism may be supported on a printed circuit board. In this example, the solar panel is positioned on an outer surface of the housing wall, so as to receive radiant energy from the sun. For example, the solar panel 66 is disposed within a housing side wall of the rangefinder 10. In still another example, the solar panel 66 is positioned within the housing upper wall. The rangefinder 10 may include more than one solar panel. The solar panel is generally planar, however, the solar panel may be curvilinear to correspond to the contours of the rangefinder housing 14. The solar panel 66 is operable to collect radiant energy from the sun and convert the sun's energy into stored electrical energy that is available for use in the operation of the rangefinder 10. The solar energy may be available to supplement that of another energy source, or may be the sole energy source. The solar panel includes a plurality of solar cells 68 arranged in a predetermined manner, such as an array. Each cell 68 is electrically connected in series by a cell connector or stringer. The dimension of each cell within the module and the corresponding array is sized to fill up the available space. The solar cells 68 operatively convert any absorbed sunlight into electricity. The cells 68 may be grouped and electrically connected and packaged together. Generally, the solar cell 68 is made from a semiconductor material, such as silicon, silicone crystalline, gallium arsenic (GaAs) or the like. When the solar cell 68 receives the sunlight, a predetermined portion of the sunlight is absorbed within the semiconductor, and the absorbed light's energy is transferred to the semiconductor material. The energy from the sunlight frees electrons loose within the semiconductor material, referred to as free carriers. These free electrons can carry electrical current, and the resulting free electron flow produces a field causing a voltage. Metal contacts are attached to the solar cell 68 to allow the current to be drawn off the cell 68 and used elsewhere. The metal contacts may be arranged in a predetermined pattern.

The solar panel may generally be formed as a laminate structure. The first layer may be a backing material, such as a foil material. The second layer may be a polymer layer. An example of a polymer material is EVA, or the like. The second layer may include the solar cells 68, and the cells may be encapsulated within the polymer layer. The solar panel 66 further includes a third or top layer of a translucent material. This top layer may include various coatings that may be either decorative or functional in nature. For example, an inner surface of the top layer has an antireflective coating, since silicon is a shiny material, and photons that are reflected cannot be used by the cell. The antireflective coating reduces the reflection of photons. In this example, the antireflective coating is a black-out screen applied over all areas of the top layer except over the cells that collect solar power. The antireflective coating may be black in color. For example, the black coating may be a material such as an acrylic or frit paint or the like. The top layer may include additional graphic coatings that visually enhance the appearance of the solar panel. In this example, an additional graphic pattern may be applied to the top glass layer, such as by a paint or silk screening process. The layers may be bonded together by the application of heat to form the laminate structure.

The power supply mechanism 64 also includes a rechargeable energy storage device 70, such as a battery, in which the electrical energy is stored. Various types of batteries 70 are available, such as lead acid, or lithium-ion or the like, and the selection is non-limiting. It should be appreciated that the rangefinder 10 may include more than one type of battery 70, such as a non-chargeable battery, i.e. lithium. In addition, the battery 70 may receive electrical energy from a plug-in electrical source, such as a typical household current socket to recharge the battery.

Referring again to FIGS. 4 and 5, the rangefinder 10 also includes a power management circuit 72 that distributes the flow of electrical energy within the rangefinder 10. The power management circuit 72 may control all facets of energy distribution, including the absorption of solar energy, flow of the solar energy to charge the battery, use of a plug in energy source, or the like. The solar panel 66 can receive energy from the sun that is converted into electrical energy and stored by the battery 70 until needed. The solar panel 66 can supply power directly to the battery. Likewise, a plug in source may also be utilized to provide power directly to the battery. The solar panel 66 of this example can output a predetermined number of amps. The power management circuit 72 may also monitor the state of charge of the battery. For example, the charge state may vary between 3-12 V depending on the operation of the rangefinder. The power management circuit 72 may also manage the distribution of electrical energy between the battery 70 and other components that utilize electrical energy, such as the telescopic mechanism 34, the display panel 40, the distance measuring mechanism 44, or the like. For example, if the predetermined energy level in the battery is less than a predetermined low voltage level, then the user may be alerted to recharge the battery. Similarly, if the predetermined energy level in the battery is greater than a predetermined high voltage level, then charging of the solar panel may be discontinued until a predetermined charge level is attached.

Referring to FIG. 6, a method of power management within a solar powered rangefinder 10 is illustrated. The methodology begins in block 100 with the step of collecting solar energy by a solar panel and converting the solar energy into electrical energy. The methodology advances to block 105 and the solar panel transmits the current or electrical energy to an energy storage device, such as a battery, to charge the battery. The methodology advances to block 110 and the battery supplies electrical energy to components requiring electrical energy for operation. The methodology advances to block 115 and checks a charge level of the battery. The methodology advances to block 120 and the charge level is provided on the display screen. The methodology advances to block 125 compares the charge level to a predetermined energy storage device charge capacity level. If the charge level is greater than the predetermined energy storage device charge capacity level, then charging of the battery is discontinued until the charge level falls below a second charge level, below which charging is resumed.

In operation, the user initiates operation of the rangefinder 10, such as by actuating the power switch. The user adjusts the eyepiece 30 to bring the target 12 being viewed through the eyepiece 30 into focus. The user may also select a mode, and the selected mode is displayed to the user on the display panel 40. A normal mode is selected under typical operating conditions. If it is raining, the user may select the rain mode so that only a target 12 greater than a predetermined distance such as 50 m is measured. In foggy or low light conditions, a reflective mode may be selected. If the target 12 is partially obstructed, the user may select a minimum predetermined distance mode, and only a target 12 greater than the predetermined distance, such as 150 m, is measured. The user then actuates the signal triggering mechanism to transmit a series of laser pulse towards the target 12, such as by actuating a signal triggering mechanism, which in this example is included with the second user actuatable mechanism 28 and pointing the locating circle at the target 12. The range finder 10 transmits a light beam 74 through the front wall first opening 36 that is vertical with the surface of the target 12. The transmitted light beam 74 strikes the target 12 and a reflected list signal 76 is reflected back to the rangefinder 10 and enters the rangefinder 10 via the front wall second opening 50, such that the reflected signal is collected by a solar collector and processed to determine the distance. The determined distance is shown on the display panel 40. In addition, the quality of the signal may likewise be displayed on the display panel 40.

The rangefinder 10 may include additional features or components that are typically found on a rangefinder, such as a cord for directly supplying current to the rangefinder, such as a power cord plugged directly into an outlet.

The present invention has been described in an illustrative manner. It is to be understood that the terminology which has been used is intended to be in the nature of words of description rather than of limitation.

Many modifications and variations of the present invention are possible in light of the above teachings. Therefore, the present invention may be practiced other than as specifically described.

What is claimed is:

1. A rangefinder apparatus for measuring a distance to a target comprising:
a housing having a front wall, an opposed rear wall, first and second side walls disposed between the front and rear walls, an upper wall, and an opposed lower wall;
a transmission device for transmitting a signal towards a target;
a receiving device for receiving a reflected signal from the target in response to the transmitted signal;
a distance measuring mechanism for determining the distance to the target using the transmitted signal and the reflected signal;
a display device in communication with the distance measuring mechanism for displaying the determined distance to the target; and
a solar power supply mechanism for supplying solar power to operate the rangefinder, wherein the solar power supply mechanism includes a solar energy collector positioned on an outer surface of the housing that is operatively in communication with an energy storage device.

2. The rangefinder of claim 1, wherein the transmission device is a laser light transmitter that emits a laser light signal.

3. The rangefinder of claim 1, wherein the receiving device is a laser light receiver.

4. The rangefinder of claim 1, further comprising a user actuatable mechanism for selectively operating the rangefinder that is disposed on the housing.

5. The rangefinder of claim 1, wherein the solar energy collector is a solar panel positioned on an outer surface of the housing, and the solar panel includes a solar cell that absorbs the solar energy.

6. The rangefinder of claim 1, further comprising a power management circuit for distributing the flow of electrical energy within the rangefinder.

7. The rangefinder of claim 1, further comprising an eyepiece secured to the housing rear wall and operatively connected to a telescopic mechanism for view the target.

8. The rangefinder of claim 7, wherein the housing front wall includes a first opening that is opposite the eyepiece along a first optical pathway for transmitting a signal to the target by the transmission device.

9. The rangefinder of claim 8, wherein the housing front wall includes a second opening that is along a second optical pathway for receiving the reflected signal by the receiving device.

10. The rangefinder of claim 1, further comprising a controller having a memory and a processor that is located within the housing for controlling operation of the rangefinder.

11. The rangefinder of claim 10, wherein the distance measuring mechanism includes a data processing software program resident in the controller for calculating the distance between the rangefinder and the target using the transmitted signal and the reflected signal.

12. The rangefinder of claim 1 wherein the energy storage device is a rechargeable battery.

13. A rangefinder apparatus for measuring a distance to a target comprising:
a housing having a front wall, an opposed rear wall, first and second side walls disposed between the front and rear walls, an upper wall, and an opposed lower wall;
a laser light transmitter disposed within the housing that emits a laser light signal towards a target;
a laser light receiver for receiving a reflected signal from the target in response to the transmitted signal;
a user actuatable mechanism disposed on the housing for selectively actuating the laser light transmitter;
a controller having a memory and a processor that is located within the housing for controlling operation of the rangefinder
a distance measuring mechanism operatively in communication with the controller for determining the distance to the target using the transmitted signal and the reflected signal;
a display device in communication with the distance measuring mechanism for displaying the determined distance to the target; and
a solar power supply mechanism for supplying solar power to operate the rangefinder, wherein the solar power supply mechanism includes a solar panel positioned on an outer surface of the housing that is operatively in communication with an energy storage device.

14. The rangefinder of claim 13, wherein the solar panel includes a plurality of solar cells that absorbs the solar energy.

15. The rangefinder of claim 13, further comprising a power management circuit for in communication with the solar panel and energy storage device distributing the flow of energy within the rangefinder.

16. The rangefinder of claim 13, further comprising an eyepiece secured to the housing rear wall and operatively connected to a telescopic mechanism for viewing the target, wherein the housing front wall includes a first opening that is opposite the eyepiece along a first optical pathway for transmitting a signal to the target by the transmission device, and the housing front wall includes a second opening that is along a second optical pathway for receiving the reflected signal by the receiving device.

17. The rangefinder of claim 13, wherein the distance measuring mechanism includes a data processing software program resident in the controller for calculating the distance between the rangefinder and the target using the transmitted signal and the reflected signal.

18. The rangefinder of claim 13 wherein the energy storage device is a rechargeable battery.

19. A method of power management for a solar powered rangefinder, the method comprising the steps of:
collecting solar energy via a solar panel positioned on a housing of the rangefinder, wherein the housing includes a front wall, an opposed rear wall, first and second side walls disposed between the front and rear walls, an upper wall, and an opposed lower wall;
converting the solar energy into electrical energy by the solar panel and storing the electrical energy in an energy storage device; and
transmitting the stored electrical energy to a laser light transmitter disposed within the housing that emits a laser light signal towards a target, a laser light receiver for receiving a reflected signal from the target in response to the transmitted signal, a user actuatable mechanism disposed on the housing for selectively actuating the laser light transmitter, a controller having a memory and a processor that is located within the housing for controlling operation of the rangefinder, a distance measuring mechanism operatively in communication with the controller for determining the distance to the target using the transmitted signal and the reflected signal, and a display device in communication with the distance measuring mechanism for displaying the determined distance to the target.

20. The method of powering a solar powered rangefinder of claim 19, the method further comprising the steps of:
determining the charge level of the energy storage device;
comparing the charge level of the energy storage device to a predetermined energy storage device charge capacity level;
terminating collection of solar energy when the charge level of the energy storage device is equal to the predetermined energy storage device charge capacity level; and
continuing collection of solar energy when the charge level of the energy storage device is less than the predetermined energy storage device charge capacity level.
